(19) United States
(12) Patent Application Publication
(10) Pub. No.: US 2012/0023755 A1
(43) Pub. Date: Feb. 2, 2012

(54) MULTIPURPOSE GARDEN TOOL

(76) Inventor: Gary Croce, Cherry Hill, NJ (US)

(21) Appl. No.: 12/848,203

(22) Filed: Aug. 1, 2010

(51) Int. Cl. B27B 33/10; B26B 9/02

(52) U.S. Cl. 30/166.3; 30/355

(57) ABSTRACT

A tool for removing unwanted plants from an area of soil is disclosed. A flexible two-edged blade bent back upon itself with both ends fastened to a common shaft. One edge acts as a knife to slice through soil and roots, moving parallel to the surface of the ground. The opposing blade edge has teeth to grasp, uproot and remove unwanted plants. The design facilitates the removal of unwanted plants or debris without touching said debris with the hands.

### FIELD OF THE INVENTION

This invention relates to garden tools, and more specifically, to a hand held garden tool that is intended to assist in removing unwanted plants and debris.

### BACKGROUND OF THE INVENTION

Undesirable plants compete with desirable plants with regard to water, nutrients and sunlight. Desirable plants produce food or provide ornamental displays such as lawns and flower gardens.

Numerous tools have been created to assist in the task of removing undesirable plants. One of the traditional tools associated with this task is the hoe. The hoe incorporates a blade that strikes the surface at an angle more or less perpendicular to the ground and is capable of penetrating the soil to cut the roots and turn over the soil to bury the undesirable plants. The physical work required to move the mass of the soil accompanied with the work of “chiseling” the soil loose is excessive and unnecessary. This results in a large expenditure of energy by the user, resulting in minimal time at task before becoming physically tired and forced to stop. Therefore, it is desirable to have an improved garden tool to assist in removing unwanted plants and debris.

### SUMMARY OF THE INVENTION

Embodiments of the present invention provide a tool for removing unwanted plants from an area of soil. One embodiment is comprised of a flexible two-edged blade bent back upon itself with both ends fastened to a common shaft. In one embodiment, the shaft is circular. One edge acts as a knife to slice through soil and roots, moving parallel to the surface of the ground. The opposing blade edge has teeth to grasp, uproot and remove unwanted plants. The design facilitates the removal of unwanted plants or debris without touching said debris with the hands.

The blade design is capable of utilizing handles of various diameters and lengths to suit the needs of the user. The advantages of this design are such that the blade may be sold separately and mounted on any readily available handle. The blade is replaceable when it becomes dull.

Many previous hoes were designed to weed large areas around crops planted in rows. Modern flower gardens and beds are not planted in rows and access is more difficult. This creates a need to remove undesirable plants growing in close proximity to desirable plants. Embodiments of the present invention are capable of cultivating and loosening soil as well as outlining the edges of beds while utilizing a tooth edged blade to lift and remove unwanted plants.

### BRIEF DESCRIPTION OF THE SEVERAL VIEWS OF THE DRAWING

FIG. 1 is a perspective view of an embodiment of the present invention.

FIG. 2 shows a side view of the garden tool.

FIG. 3 shows a top view of the garden tool.

FIG. 4 shows an un-mounted blade.

FIG. 5 shows details of a blade.

FIG. 6 shows an alternate embodiment of the present invention.

FIG. 7 shows installation of a blade.

### DETAILED DESCRIPTION OF THE INVENTION

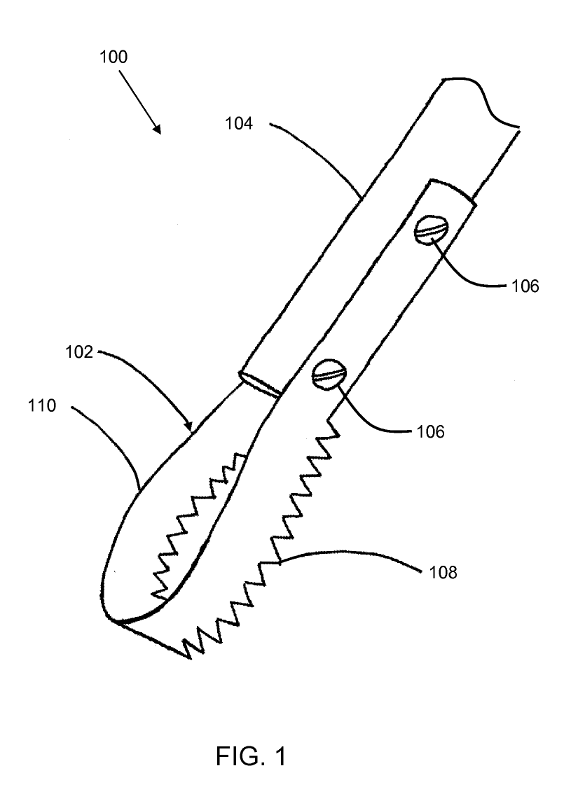

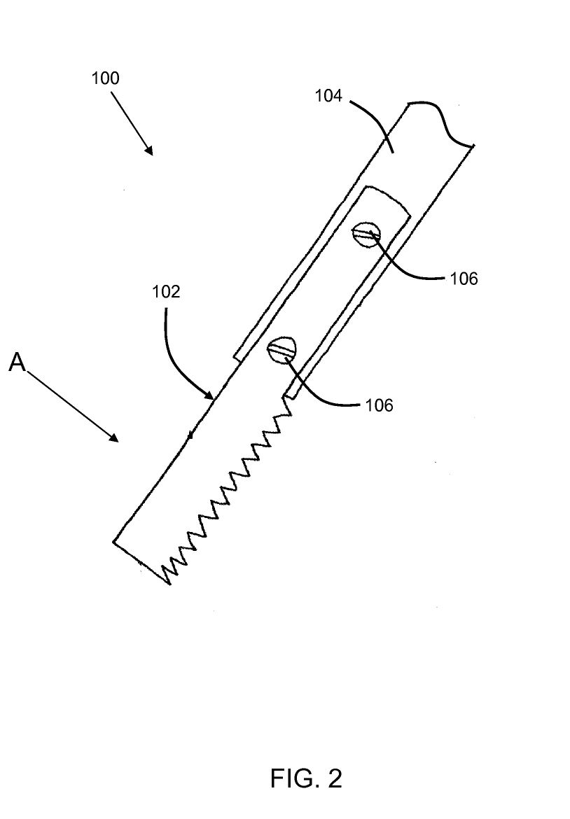

FIG. 1 is a perspective view of an embodiment of a tool 100 in accordance with an embodiment of the present invention, and FIG. 2 is a corresponding side view. Blade 102 is mounted on shaft 104 via a plurality of fasteners 106. In one embodiment, the fasteners 106 are threaded bolts. Blade 102 is comprised of a linear member having a toothed edge 108 and a knife edge 110. In one embodiment, shaft 104 has a length ranging from about 3 feet to about 5 feet, and is suitable for use while standing. In another embodiment, shaft 104 has a length ranging from about 6 inches to about 18 inches, and is suitable for use while kneeling or sitting. In one embodiment, the shaft is comprised of wood. In another embodiment, the shaft is comprised of fiberglass. In one embodiment, the shaft is cylindrical.

The shape of the blade 102 is in a U-shape, and is such that force is concentrated into a small area. This permits the operator to expend less energy and work for longer periods. The relatively narrow width of the tool head permits the removal of unwanted plants in close proximity to obstructions or desirable plants.

The toothed edge 108 of the blade 102 serves to uproot and grasp unwanted plants for removal. The knife edge 110 of the blade 102 serves to slice through soil and cut roots and can be used to outline flower beds and perimeters. In one embodiment, blades 102 can be readily mounted on user-supplied shafts 104 of varying lengths and diameters. Furthermore, with embodiments of the present invention, the blade is easily replaced when worn or damaged.

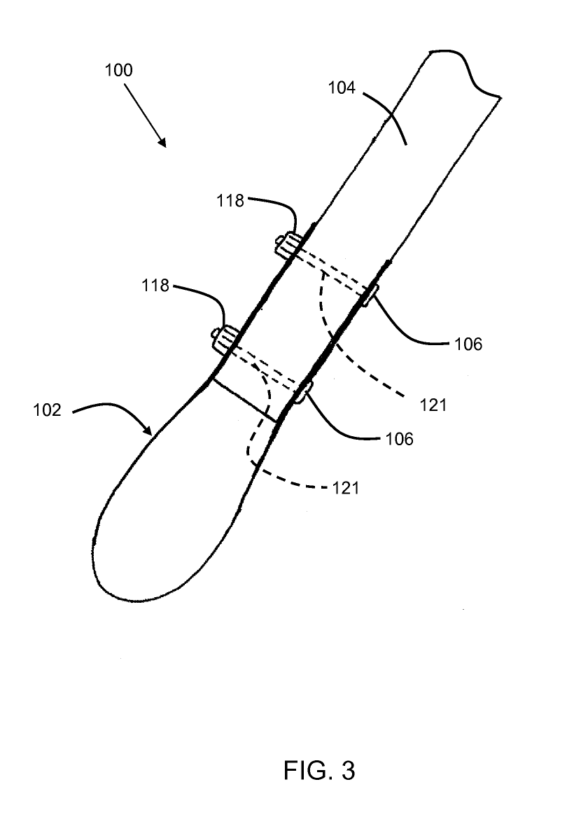

FIG. 3 shows a top view of the garden tool, as viewed from arrow A of FIG. 2. In this view, nuts 118 are shown, which secure fasteners 106, and thus, blade 102 to shaft 104. Shaft 104 comprises a plurality of fastener openings 121 for receiving fasteners 106, which are secured by nuts 118 threaded onto the end of each fastener 106. The blade 102 is secured to the shaft 104 such that the blade is disposed on the outer surface of shaft 104. This serves to allow convenient replacing of worn blades.

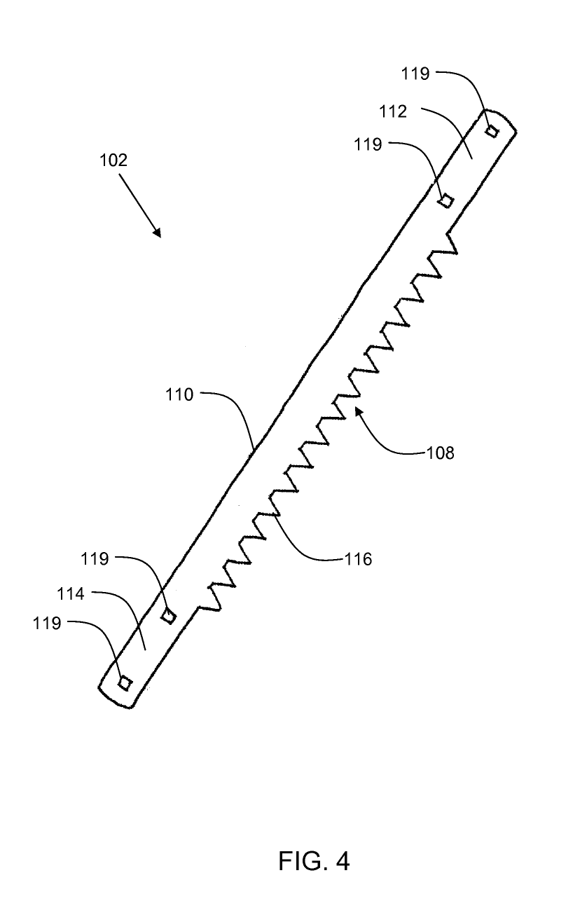

FIG. 4 shows details of blade 102. Blade 102 is comprised of a linear member that comprises knife edge 110 and toothed edge 108. In one embodiment, the teeth (indicated generally as reference 116) are of a saw-tooth shape. Blade 102 also comprises un-toothed blade portions 112 and 114, which each have a plurality of mounting openings 119 thereon, for allowing fasteners 106 (FIG. 3) to traverse through the mounting openings 119 and through the fastener openings 121 of shaft 104 (FIG. 3), thereby securing the blade 102 to the shaft. In one embodiment, blade 102 is comprised of steel, and has a TPI (teeth-per-inch) count value ranging from 4 to 12. In one embodiment, each tooth has the shape of an isosceles triangle. In a particular embodiment, each tooth has a negative rake angle in the range of about 10 to about 30 degrees, which provides for engagement of weeds to be removed from a garden.

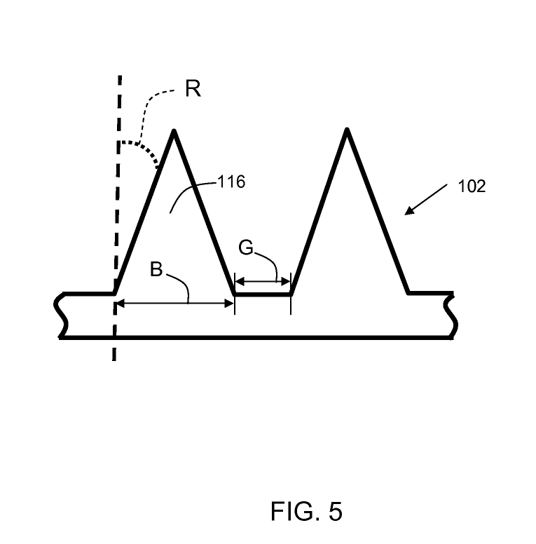

FIG. 5 shows details of blade 102. In one embodiment, each tooth 116 has a negative rake angle R in the range of about 10 to about 30 degrees, and gap G between each tooth. In one embodiment, inter-tooth gap G is approximately one fourth (¼) to one third (⅓) of the length of the base B of the tooth 116. The gap G aids in trapping weeds and other debris that is intended to be picked up during use. In one embodiment, the blade configuration is 4 teeth per inch with a 3/16 inch tooth base and 1/16 inch inter-tooth gap for a total tooth plus inter-tooth gap of ¼ inch.

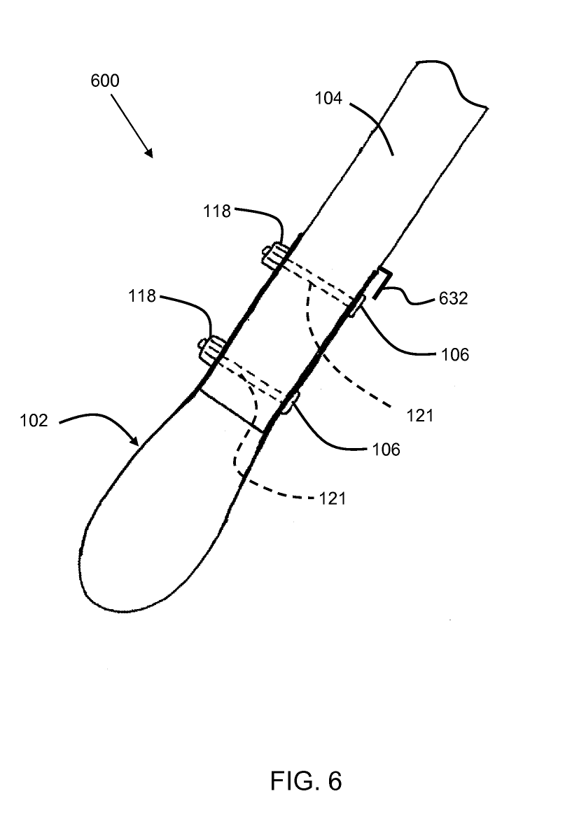

FIG. 6 shows an alternate embodiment of a tool 600 in accordance with an embodiment of the present invention. Tool 600 is similar in construction and operation to tool 100, with the exception of blade ridge 632. Blade ridge 632 serves as an alignment aid during installation of a new blade 102. Periodically, blade 102 may be replaced by removing an old blade by removing nuts 118 and removing fasteners 106 to release the old blade. The new blade 102 is then installed by positioning an un-toothed blade portion of the blade against blade ridge 632, which positions the blade such that the openings 119 (FIG. 4) in the blade align with corresponding fastener openings 121 in the shaft 104. The blade 102 is then bent to allow the openings in the other un-toothed blade portion of the blade to engage fasteners 106.

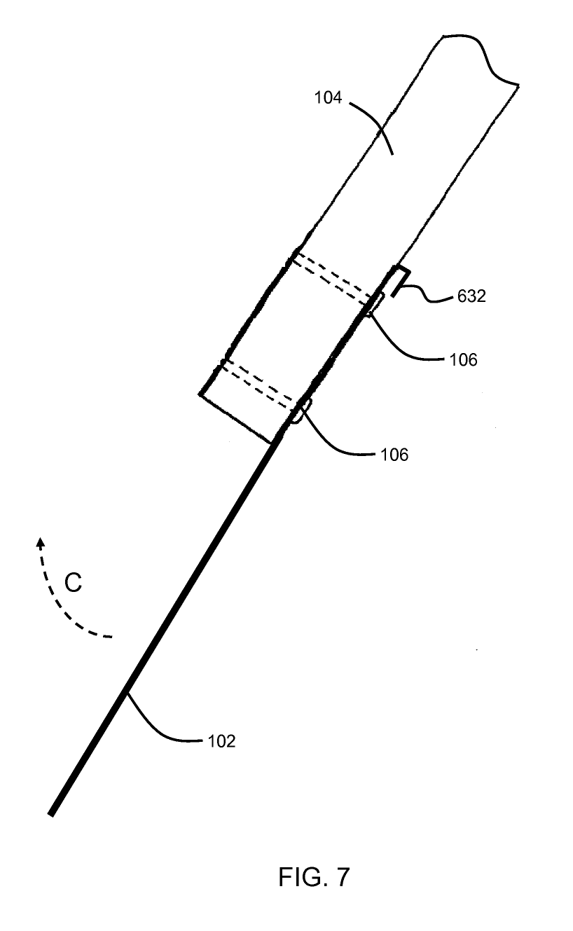

FIG. 7 shows the embodiment of FIG. 6 during installation of a new blade 102. In one embodiment, a blade 102 is available to the customer as a straight blade. The blade 102 is affixed to one side of shaft 104 and then bent in the direction indicated by arrow C such that the opposite end of blade 102 engages fasteners 106 on the side of shaft 104 that has nuts 118 to secure the blade 102. The fully installed configuration is depicted in FIG. 6.

Although the description above contains many specific details, these should not be construed as limiting the scope of the invention, but merely as providing illustrations of some of the presently preferred embodiments of the present invention. The present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A tool comprising,
a shaft, the shaft comprising a plurality of fastener openings at one end;
a blade, the blade comprising a linear member disposed in a U-shape, comprising a toothed edge, the toothed edge comprising a plurality of teeth, and an un-toothed edge, and further comprising an un-toothed blade portion at each end of the linear member, wherein a plurality of mounting openings are disposed in each un-toothed blade portion;
a plurality of fasteners, the plurality of fasteners configured and disposed to traverse the plurality of mounting openings and the plurality of fastener openings, wherein the blade is secured to the shaft with the un-toothed blade portions disposed on the outer surface of the shaft.

2. The tool of claim 1, wherein the shaft is cylindrical.

3. The tool of claim 2, wherein the plurality of fasteners comprises two fasteners.

4. The tool of claim 1, wherein the toothed edge of the blade comprises a teeth-per-inch count ranging from 4 to 12 teeth per inch.

5. The tool of claim 4, wherein the toothed edge of the blade comprises teeth in the shape of an isosceles triangle.

6. The tool of claim 4, wherein each tooth of the toothed edge of the blade comprises a negative rake angle in the range of about 10 to about 30 degrees.

7. The tool of claim 5, wherein an inter-tooth gap is disposed between the teeth of the toothed edge of the blade.

8. The tool of claim 7, wherein each tooth has a base, and wherein the inter-tooth gap ranges from one fourth to one third the length of the base of each tooth.

9. The tool of claim 1, wherein the blade is comprised of steel.

10. The tool of claim 1, wherein the shaft is comprised of wood.

11. The tool of claim 1, wherein the shaft is comprised of fiberglass.

12. The tool of claim 1, further comprising a blade ridge disposed on the shaft, the blade ridge adapted to position the blade such that the mounting openings of an un-toothed blade portion of the blade align with the corresponding fastener openings.

13. A blade for a garden tool, comprising:
a linear member comprising a toothed edge, the toothed edge comprising a plurality of teeth, and an un-toothed edge, and further comprising an un-toothed blade portion at each end of the linear member, wherein a plurality of mounting openings are disposed in each un-toothed blade portion.

14. The blade of claim 13, comprising a teeth-per-inch count ranging from 4 to 12 teeth per inch.

15. The blade of claim 13, wherein the toothed edge of the blade comprises teeth in the shape of an isosceles triangle.

16. The blade of claim 15, wherein each tooth of the toothed edge of the blade comprises a negative rake angle in the range of about 10 to about 30 degrees.

17. The blade of claim 13, wherein an inter-tooth gap is disposed between the teeth of the toothed edge of the blade.

18. The blade of claim 17 wherein each tooth has a base, and wherein the inter-tooth gap ranges from one fourth to one third the length of the base of each tooth.

19. The blade of claim 13, wherein the blade is comprised of steel.

20. The blade of claim 13, wherein the plurality of mounting openings comprises two mounting openings.
